(19) United States
(12) Patent Application Publication
(10) Pub. No.: US 2019/0329080 A1
(43) Pub. Date: Oct. 31, 2019

(54) BELOW STRUCTURAL OBSTRUCTION FIRE SPRINKLER INSTALLATION METHOD AND HEAT COLLECTOR SYSTEM

(71) Applicant: Firebird Sprinkler Company LLC, Ann Arbor, MI (US)

(72) Inventor: Jeffrey J. Pigeon, Ann Arbor, MI (US)

(21) Appl. No.: 16/509,797

(22) Filed: Jul. 12, 2019

Related U.S. Application Data
(63) Continuation-in-part of application No. 16/208,649, filed on Dec. 4, 2018.
Application No. 16/208,649 is a continuation-in-part of application No. 15/598,808, filed on May 18, 2017.
Application No. 15/598,808 is a continuation-in-part of application No. 15/257,961, filed on Sep. 7, 2016, now Pat. No. 10,149,992.
Application No. 15/257,961 is a continuation of application No. 14/661,302, filed on Mar. 18, 2015, now abandoned.
(60) Provisional application No. 62/215,058, filed on Sep. 7, 2015.
(60) Provisional application No. 62/019,527, filed on Jul. 1, 2014.
(60) Provisional application No. 61/955,253, filed on Mar. 19, 2014.
(60) Provisional application No. 62/697,009, filed on Jul. 12, 2018.

(51) Int. Cl. A62C 35/68; A62C 37/12; A62C 31/02; A62C 3/00; A62C 37/11; A62C 35/64; B05B 1/26

(52) U.S. Cl. CPC A62C 35/68; A62C 37/12; A62C 31/02; B05B 1/267; A62C 37/11; A62C 35/64; A62C 3/002

(57) ABSTRACT

A fire suppression system specially adapted for placement in a warehouse having a ceiling deck supported by exposed metallic structural support members. The fire suppression system includes a supply line that feeds water to an array of self-activating sprinkler heads. The sprinkler heads are located near or below the exposed metallic structural support members to achieve many performance-enhancing and cost-saving benefits. One or more sprinkler heads may include respective heat collectors designed to capture upwardly rising heat plumes. The heat collectors agitate the collected air to improve activation responsiveness. In some embodiments, the heat collectors include vent-like aspiration ports coupled with exterior louvers to scavenge heat from a ceiling jet.

### CROSS REFERENCE TO RELATED APPLICATIONS

This application is a Continuation-in-Part of U.S. application Ser. No. 16/208,649 filed Dec. 4, 2018, which is a Continuation-in-Part of U.S. application Ser. No. 15/598,808 filed May 18, 2017, which is a Continuation-in-Part of U.S. application Ser. No. 15/257,961 filed Sep. 7, 2016, which claims priority to Provisional Patent Application No. 62/215,058 filed Sep. 7, 2015, and is a Continuation-in-Part of U.S. application Ser. No. 14/661,302 filed Mar. 18, 2015, which claims priority to Provisional Patent Application No. 62/019,527 filed Jul. 1, 2014 and to Provisional Patent Application No. 61/955,253 filed Mar. 19, 2014, and this application also claims priority to Provisional Patent Application No. 62/697,009 filed Jul. 12, 2018, the entire disclosures of which are hereby incorporated by reference and relied upon.

### BACKGROUND OF THE INVENTION

Certain kinds of building structures are very large with relatively high ceiling decks that have metallic structural support members exposed to the area below. Although such building types can be put to many different uses, one common application is as a formal storage facility capable of storing large quantities of commercial goods/equipment stacked high on storage racks. For the sake of convenience, all kinds of large building structures with a high ceiling deck supported by exposed metallic structural support members will be referred to generally as “warehouses.” The term “warehouse” is thus used in a representative capacity to describe the type of structure and not the use to which the structure is put. That is to say, the term “warehouse” as used herein can mean any type of large structure with a high ceiling deck supported above exposed metallic structural support members, even in cases where the building structure is used as an office building, a retail building, a service center, a display facility, an activity center, a training facility, a livestock shelter or any other purpose. The term “warehouse” as used herein does not include any structure in which an intervening barrier, like a drop ceiling, is placed under the metallic structural support members.

In many cases, the commercial value of items (including people and/or animals) contained within a warehouse can often be many times greater than the cost of the warehouse itself. That is to say, there is significant commercial incentive to carefully safeguard storage items while sheltered in a warehouse. The term “storage area” refers to the space sheltered under the ceiling deck in a warehouse. The term “storage items” refers to everything contained in a storage area.

Typically, there is a flammable quality to storage items—either the storage items per se are flammable, or their boxing/crating/wrapping is combustible, or they are carried on pallets made of combustible wood. In most warehouses, ignition sources are ubiquitous. Sparks from forklift trucks and dropped cigarettes are common sources of accidental ignition. The orderly placement of large quantities of combustible storage items separated by narrow air shafts (flues) can make ideal conditions for a fire to rapidly grow. Heat from a fire in the storage area will directly pass through the metallic structural support members to the ceiling deck above. In many cases, a warehouse filled with storage items can be likened to a tinder box full of valuables. These and other factors make warehouses a special challenge for fire fighters.

For many years, automatic fire suppression systems have been used to protect warehouses. Examples of some fire suppression systems and methods of installation are described in detail in my U.S. Pat. No. 8,602,118 (issued Dec. 10, 2013) and U.S. Pat. No. 8,733,461 (issued May 27, 2014), the entire disclosures of which are hereby incorporated by reference and relied upon.

In the typical fire suppression system, a sprinkler head is positioned near the ceiling deck where hot ceiling jets spread from a heat plume. In FIGS. 1-3, representative examples of prior art sprinkler systems are shown in phantom and generally indicated at A. Heat plumes rising from a fire in the warehouse are indicated a B. Within a fire plume B, the highest temperature and highest velocity will be found near its centerline. When the fire plume B impinges on the ceiling, heat and buoyant gases are redirected, flowing radially outward from the impingement point in the form of a ceiling jet C. The ceiling directs the convective heat energy in the ceiling jet C toward the nearest sprinkler heads A.

A heat activated device (i.e., trigger) built into the common automatic sprinkler head A holds a cap or valve mechanism closed under normal conditions. At the design temperature, the trigger comes apart and the cap or valve opens, releasing water through the sprinkler head A. The forceful spray of water from the sprinkler head A is dispersed over a specified coverage area. The water spray combats the fire burning within the coverage area, and wets surrounding materials not yet combusting. Furthermore, the water spray cools the surrounding air through evaporation and displaces air with inert water vapor.

In the prior art, fire codes routinely specify that sprinkler heads A must be located, typically, twelve-to-eighteen inches (12-18 in.) from the ceiling deck in order to take advantage of reliably high heat contained in a ceiling jet C. See, for example, U.S. Pat. No. 5,915,479 which describes fire sprinklers located approximately 1 foot below a ceiling deck. Placing the prior art sprinkler heads A in the expected path of a ceiling jet C assures a timely response in the event of a fire. Installers of fire suppression systems are required to follow established protocols and are held accountable through the building/fire inspection process. For this reason, installers are not at liberty to locate prior art sprinkler heads A outside the code-specified distance from the ceiling deck. Installers of prior art fire suppressions systems must follow the rules or risk failure to pass inspections and/or expose to legal liability.

In perhaps all cases of large warehouse buildings, the metallic structural support members directly below the ceiling deck are taller than eighteen inches (18 in.), thus necessitating that the prior art supply lines be run (plumbed) through/around the metallic structural support members. In cases where the metallic structural support members are solid I-beams, it is only possible to run a prior art supply line parallel with the I-beams unless long extensions are used to locate the sprinkler heads close to the ceiling deck. In cases where the metallic structural support members are trusses, a prior art supply line can be run either parallel with the trusses or routed perpendicular to pass through its network of crisscrossing webs. It is of course time-consuming and cumbersome to locate supply lines through/around the metallic structural support members, while avoiding obstacles like HVAC ductwork and electrical lines that are also commonly tucked in-between the metallic structural support members.

All fire sprinkler heads A are configured to emit water spray in a defined geometry D. Often, the defined geometry D is in the shape of a cone, however other shapes are common. In addition to increased installation difficulty and costs, the prior art practice of locating sprinkler heads A twelve-to-eighteen inches (12-18 in.) from the ceiling deck also results in significant disturbance of the emitted water spray patterns in warehouse applications. Prior art sprinkler heads A that are tucked in-between the metallic structural support members near the ceiling deck must spray through and around obstacles (including HVAC ductwork), which causes serious disruption of the intended water spray geometry D and uneven wetting over the intended coverage areas.

Another issue concerns water density. When the sprinkler heads A are mounted near the ceiling deck in a tall warehouse structure, the sprinkler heads A will be far away from the floor where most fires originate. Large clearances between and floor-level combustibles could mean that the correct water density is not delivered to a fire. This is because heat from the fire plume B creates temperatures or draft conditions that cause water droplets from distant sprinkler heads A to evaporate before penetrating and cooling the plume B.

Heat collectors have been proposed in some applications to reduce the time a fire takes to activate sprinkler heads A. In theory, a heat collector will enhance both convective and radiant heating effects. In practice, however, heat collectors have been largely disfavored in the fire protection industry. One reason is that heat collectors tend to produce a dead air space—especially bell-shaped heat collectors. Some studies have suggested that dead air spaces under heat collectors can repel a convective flow of hot gases (from plume B or ceiling jet C), thereby actually retarding activation of the sprinkler head during the incipient stages of a fire. Another reported problem with heat collectors has been that they are only effective when located directly within the fire plume B. Some studies have suggested that sprinkler heads A equipped with heat collector devices that were located outside the plume B sometimes did not respond at all because the heat collector would deflect the convective heat flow of the ceiling jet C. That is, there is some evidence to suggest, counterintuitively, that a prior art heat collector may even delay activation because it traps a bubble of cool dead air below and prevents the ceiling jet from reaching the sprinkler from above.

There is therefore a need in the fire suppression field to create an improved automatic fire-fighting system for large warehouse applications that will be less costly, easier and faster to install, and perform better than current practices.

### BRIEF SUMMARY OF THE INVENTION

In a combination fire suppression system and warehouse, the warehouse has a ceiling deck that covers a storage area. A plurality of metallic structural support members support the ceiling deck. The metallic structural support members are exposed to the storage area such that heat from a fire in the storage area will directly contact the metallic structural support members without an intervening barrier. The metallic structural support members are arranged in parallel and separated one from another by a lateral spacing. Each metallic structural support member has a top chord in direct contact with the ceiling deck and a bottom chord exposed to the storage area below. At least one elongated tubular supply line is configured as a conduit to carry liquid water. The supply line extends continuous and uninterrupted within the storage area. The supply line is operatively connected to a source of liquid water. A plurality of sprinkler heads extend from the supply line. Each sprinkler head receives liquid water from the supply line and is configured to emit the water in a spray of defined geometry. Each the sprinkler head has a temperature-sensitive trigger operatively associated with a water release valve. And wherein the sprinkler heads are suspended such that their respective water sprays of defined geometry fall entirely below the bottom chords of all metallic structural support members.

The invention also contemplates a method for installing a fire suppression system in a warehouse, of the type that has a ceiling deck supported by exposed metallic structural support members. The fire suppression system includes a supply line which has a plurality of sprinkler heads that extend therefrom. The supply line is connected to a liquid water source. The method is characterized by the step of suspending the sprinkler heads near or below a plurality of the exposed metallic structural support members so that their respective water sprays of defined geometry fall entirely below the bottom chords of all metallic structural support members.

A primary feature of this invention is to install the sprinkler heads near or below the bottom chord of the trusses (or I-beams as the case may be) in order that their respective water sprays of defined geometry fall entirely below the bottom chords of all metallic structural support members. The prior art routinely places sprinkler heads so that their triggering elements are within 12-18 inches of the ceiling deck. In prior art cases when the supply line is below the trusses/I-beams, additional pipe is used to elevate the sprinkler heads to 12-18 inches from the ceiling deck. This invention eliminates all complications required to elevate the sprinkler heads into close proximity with the ceiling deck, by decisively installing the sprinkler heads below the trusses/I-beams. This technique offers many advantages, including eliminating obstructions of the spray pattern by the truss members, use the heat from fires to deflect off the trusses/I-beams which in turn trigger the sprinkler head. The present invention allows the sprinkler heads to be installed in a less obstructive way, which will make less susceptible complications and more effective. Advantageously, the teachings of this invention enable the use of less water and less pressure to combat fires, resulting in material and labor savings in installation.

For over a century, the common practice has been to install sprinkler heads within 12-18 inches of the ceiling deck. Because heat rises, this was naturally thought to be wise. The present invention challenges these long-held beliefs by liberating the sprinkler heads to be suspended entirely below the metallic trusses/I-beams in warehouse applications.

### BRIEF DESCRIPTION OF THE SEVERAL VIEWS OF THE DRAWINGS

These and other features and advantages of the present invention will become more readily appreciated when considered in connection with the following detailed description and appended drawings, wherein:

FIG. 1 is a perspective view of a warehouse ceiling deck supported by truss-type metallic structural support members;

FIG. 2 is a simplified elevation view of a warehouse showing three variations of sprinkler head fixtures suspended below a metallic structural support member;

FIG. 3 is a cross-sectional view taken generally along lines 3-3 in FIG. 2;

FIG. 4 is a simplified, fragmentary view of an upright sprinkler head fitted with a heat collector according to one embodiment of the invention suspended below an I-beam style metallic structural support member;

FIG. 5 is an enlarged view of the sprinkler head and heat collector of FIG. 4 shown interacting with heat plume and ceiling jet;

FIG. 6 is a view as in FIG. 5 but showing an alternative embodiment pendant style sprinkler head and heat collector interacting with heat plume and ceiling jet;

FIG. 7 is a perspective view of an alternative embodiment side-discharge style sprinkler head and heat collector;

FIG. 8 is a cross-sectional view of the side-discharge sprinkler head and heat collector of FIG. 7; and

FIG. 9 depicts an alternative embodiment in which the heat collector is made in two separable parts and fitted with heat antennae features.

### DETAILED DESCRIPTION OF THE INVENTION

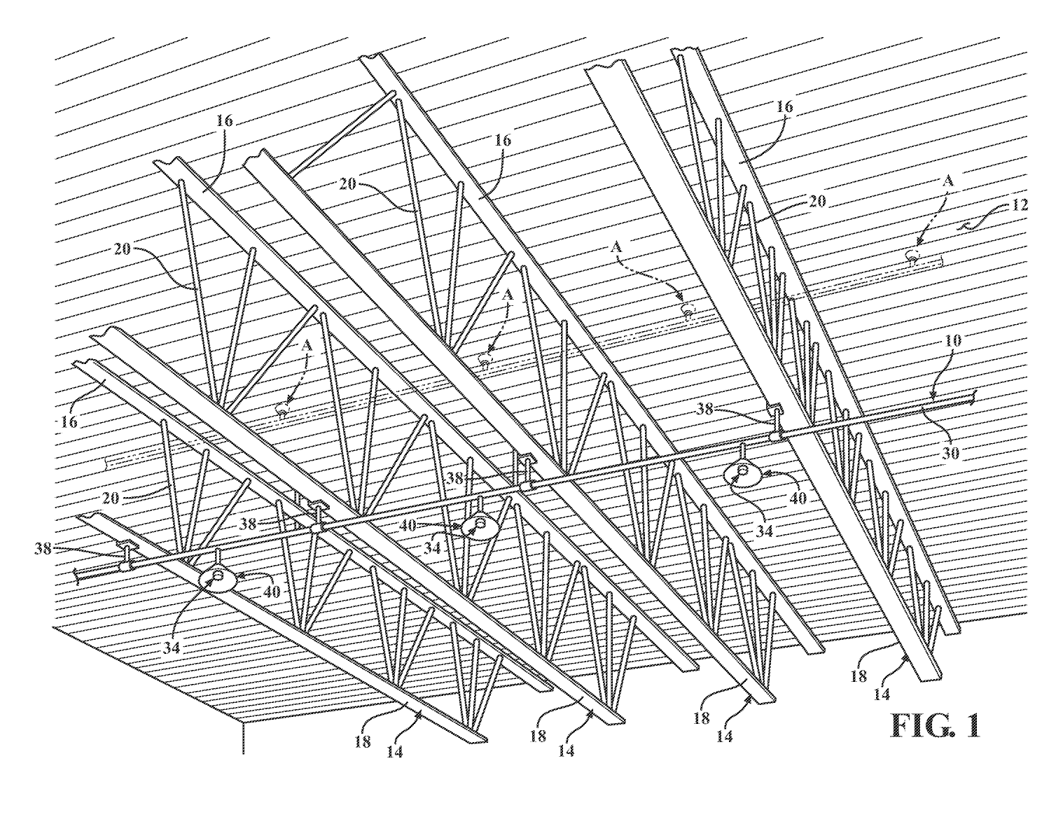

Referring to the figures, wherein like numerals indicate like or corresponding parts throughout the several views, a fire suppression system according to one exemplary expression of the present invention is generally shown at 10 in FIGS. 1-3. The fire suppression system 10 is depicted in combination with warehouse of the type having a ceiling deck 12 covering a storage area. A plurality of metallic structural support members 14 uphold the ceiling deck 12. Although some aspects and features of the present invention may be usefully applied in the context of wooden support beams, the core novel concepts of this present invention are best exploited in combination with metallic structural support members 14.

To reiterate, building structures sheltering a large area and which have a high ceiling deck 12 supported by metallic structural support members 14 can be put to many different uses. One common application is as a storage facility for storing large quantities of commercial items stacked high on storage racks, however other uses are also common including, but not limited to, office buildings, retail buildings, service centers, display facilities, activity centers, training facilities, livestock shelters and the like. The term “warehouses” is used herein to refer generally to any structure having a high ceiling deck 12 supported above exposed metallic structural support members 14. The term “warehouse” does not include any structure in which an intervening barrier, like a drop ceiling, is placed under the metallic structural support members 14. The term “storage area” refers to the space sheltered under the ceiling deck in a warehouse. The term “storage items” refers to everything contained in a storage area.

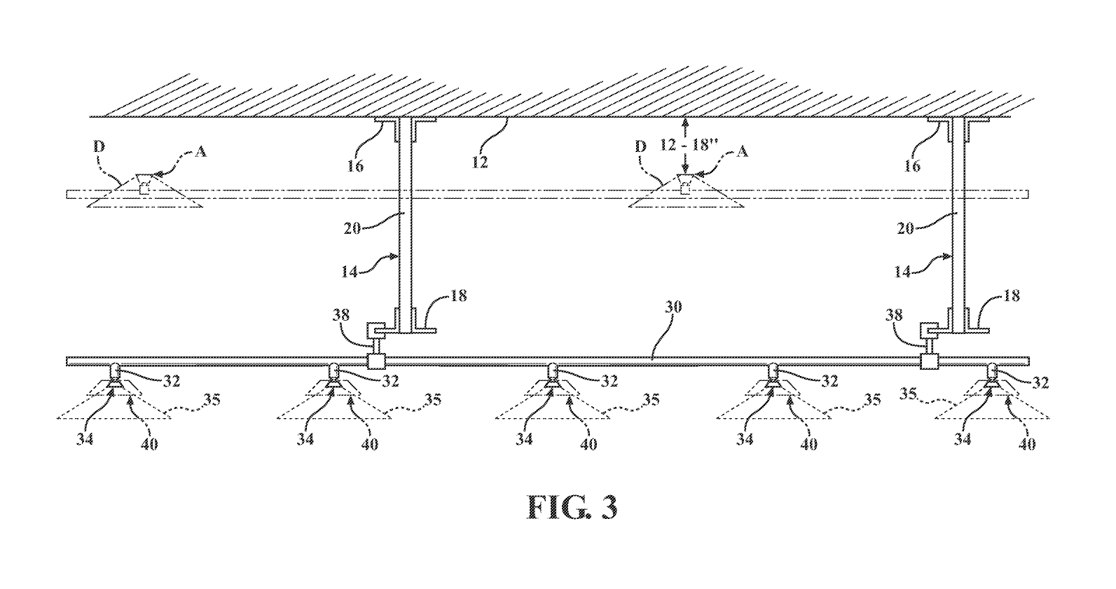

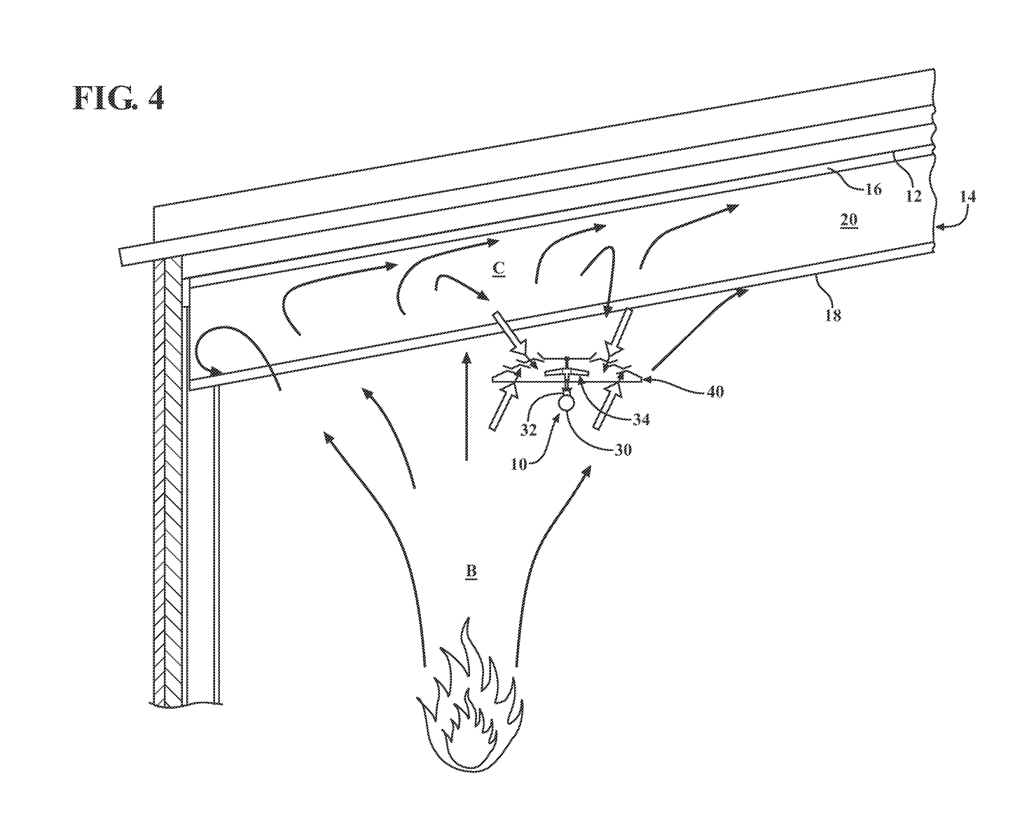

As perhaps best shown in FIG. 1, the metallic structural support members 14 are typically arranged in parallel and separated one from another by a generally consistent lateral spacing, e.g., ten feet on-center. Each metallic structural support member 14 has a top chord 16 in direct contact with the ceiling deck 12 and a bottom chord 18 exposed to the storage area below. The chords 16, 18 could be unitary elements as suggested in the view of FIG. 1, or build-up from opposing angles as suggested in the view of FIG. 3. In cases where the metallic structural support member 14 comprises a truss (e.g., FIGS. 1-3), bracing between the top 16 and bottom 18 chords is accomplished by a plurality of webs 20 that are arranged to form a series of locked triangular forms. In cases where the metallic structural support member 14 comprises an I-beam (e.g., FIG. 4), a monolithic web extends between the top 16 and bottom 18 chords. Naturally, the metallic structural support members 14 may be shaped in any suitable manner.

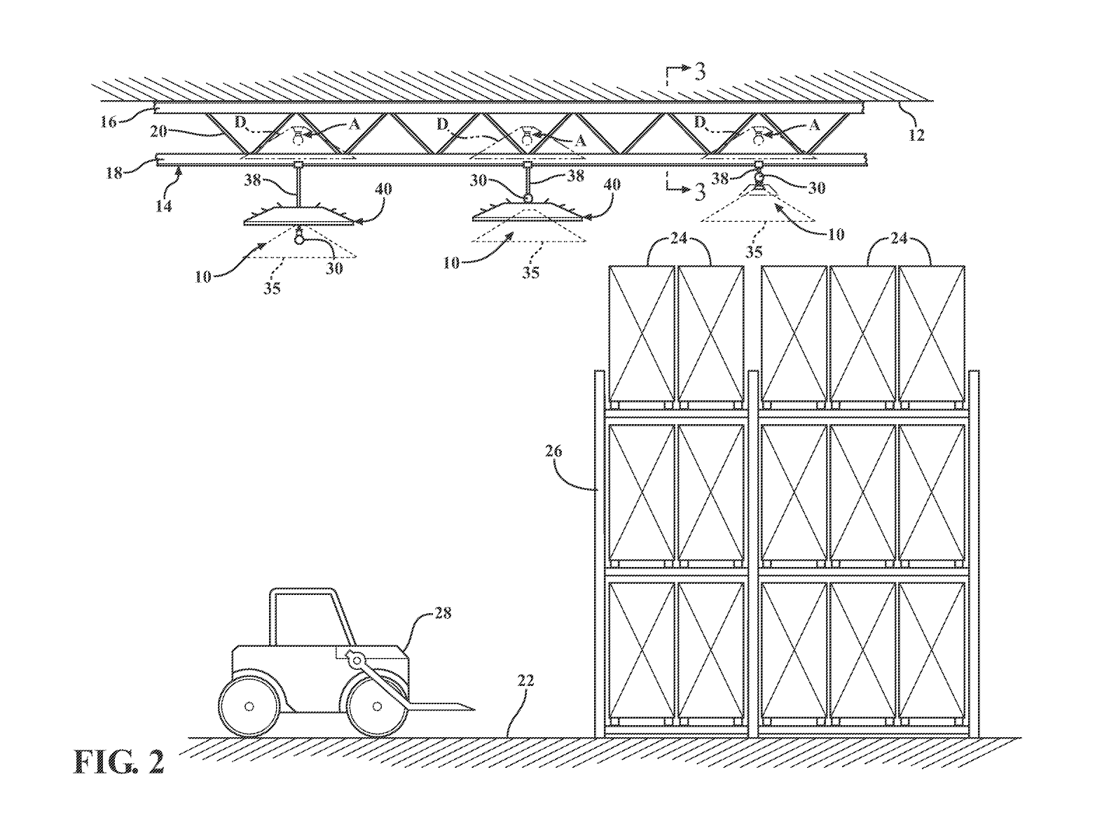

In the example of FIGS. 1 and 2, the ceiling deck 12 is shown as a flat pitch. However, ceiling decks 12 oriented at a skewed or pitched angle relative to the floor 22 are also certainly possible, as suggested in the view of FIG. 4. For large warehouse buildings, the metallic structural support members 14 will always be taller than eighteen inches (18 in.). That is, the bottom chords 18 are always more than eighteen inches (18 in.) below the ceiling deck 12.

In FIG. 2, the fire suppression system 10 is located in the interior space of a warehouse. The warehouse has a floor 22. Warehouses are specially adapted and utilized to safe-keep large quantities of storage items 24. For context, storage racks 26 are shown in FIG. 2 supporting a representative number of storage items 24 in an organized, yet densely packed, manner. Commonly, a warehouse facility will arrange many storage racks 26 in opposite-facing pairs separated by aisles large enough for a forklift 28 to maneuver. The common storage rack 26 has a plurality of shelves upon which are placed the storage items 24. The storage items 24 may be carried on standard pallets to facilitate handling with a forklift.

Warehouses tend to be unique types of building structures. They are typically very large with relatively high ceiling decks 12 in order to storage large quantities of storage items 24 that may be stacked high on storage racks 26. The orderly placement of large quantities of combustible storage items 24 separated by narrow air shafts (flues) can make ideal conditions for a fire to rapidly grow. Warehouses tend to be constructed as economically as possible, which means that more times the metallic structural support members 14 are left exposed to the storage area. As a result, heat from a fire in the storage area will directly contact the metallic structural support members 14 without an intervening barrier such as a drop ceiling. These and other factors make warehouses a special challenge to protect in the event of fire.

The fire suppression system 10 of the present invention includes at least one elongated tubular supply line 30 configured as a conduit to carry liquid water. Typically, most warehouse applications will require installation of a plurality of supply lines 30. The several elongated tubular supply lines 30 within a warehouse are fed, usually via a common manifold, with water or other suitable liquid from a source under pressure. The source of liquid water may be from a municipal water main, an on-site water tank or the like. Although FIGS. 1-4 show the supply lines 30 arranged generally perpendicular to the metallic structural support members 14, they could just as easily be oriented parallel to the metallic structural support members 14. The supply line 30 includes a plurality of saddles 32 perpendicularly radiating therefrom. The saddles 32 form points of egress for water flowing through the supply line 30.

As is well-known in the art, sprinkler heads 34 are disposed in series along each supply line 30 at regular intervals. Each sprinkler head 34 is coupled to a respective one of the saddles 32 and configured to receive liquid water from the supply line 30 for spray dispersion of defined geometry 35 over a designated coverage area. Each sprinkler head 34 is fitted with a temperature-sensitive trigger that is operatively associated with a water release valve. In this manner, each sprinkler head 34 is independently activated in response to heat sufficient to release its trigger.

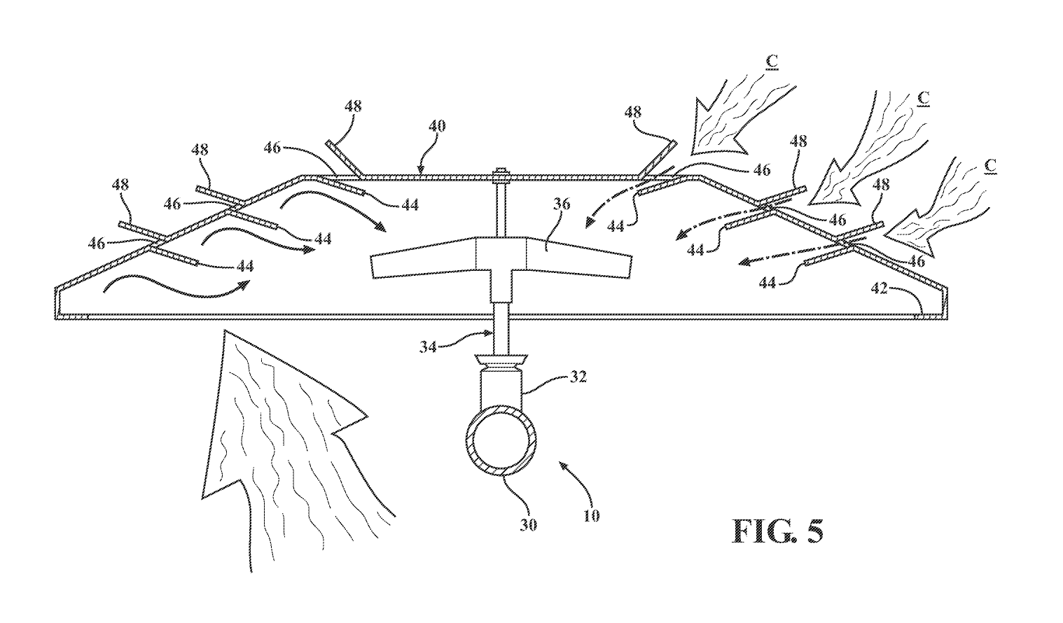

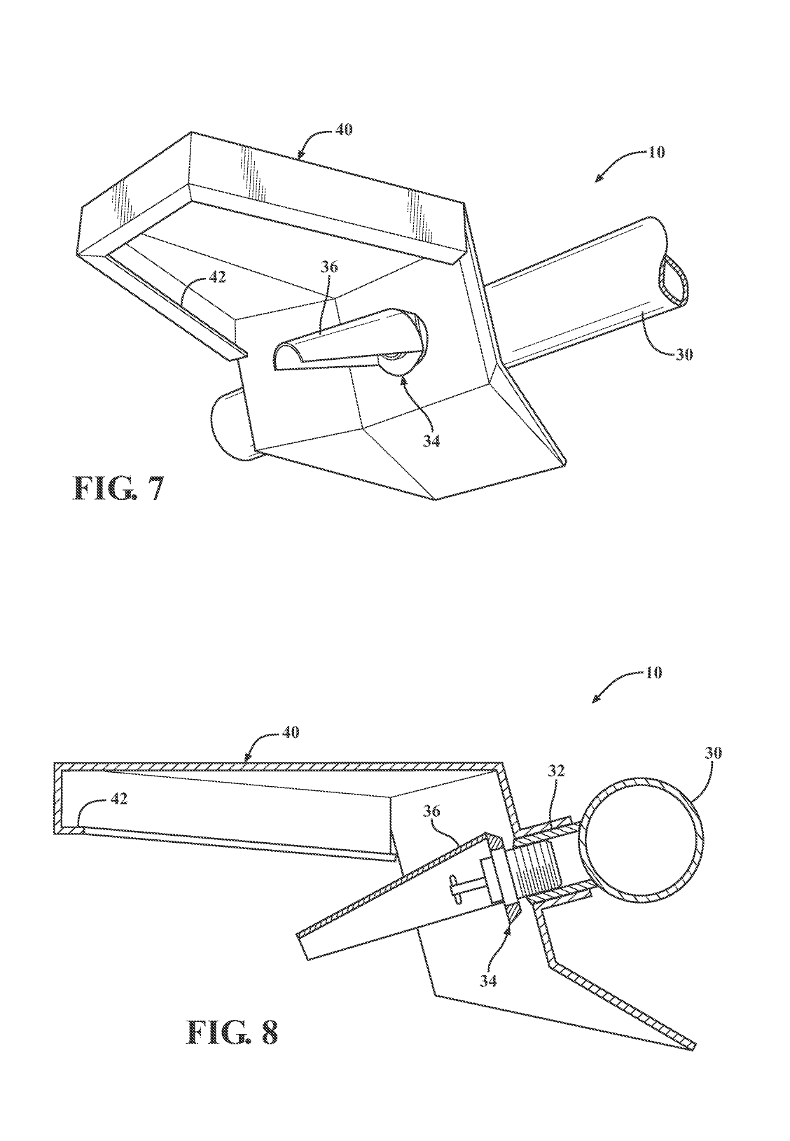

The principles of this invention are intended to be readily adaptable most types of sprinkler heads 34. For example, FIGS. 1, 3 and 6 show various pendant-type sprinkler heads 34. FIG. 2 shows a combination of upright and pendant style sprinkler heads 34. FIGS. 4-5 depict upright style sprinkler heads 34. And FIGS. 7-8 show exemplary side-discharge sprinkler head 34. The various depictions are intended to serve as representative examples for the many different types of styles of sprinkler heads 34.

The sprinklers 34 of FIGS. 1-3 are designed to produce a spray dispersion of defined geometry 35 that results in a traditional circular coverage area. The sprinklers 34 of FIGS. 4-6 are designed to produce spray geometries that result in non-circular spray patterns like those described, for example, in U.S. Pat. No. 9,675,827 issued Jun. 13, 2017, the entire disclosure of which is hereby incorporated by reference. Non-circular sprinkler heads 34 like these are designed to produce spray geometries that result in elliptical coverage areas. Of course, the sprinkler heads 34 could be configured to produce spray dispersion geometries that result in different water distribution patterns, including but not limited to straight line (e.g., a fire hose), square/rectangular, semi-circular and so forth. In most cases, the coverage area of a sprinkler head 34 will be determined by the type of fire hazard, physical characteristics of the warehouse and/or the configuration of storage items 24 to be protected.

The non-circular sprinkler heads 34 of FIGS. 4-8 each include a deflector 36 configured to disperse the liquid water in a jet stream along a downward trajectory. The jet stream may be so condensed and narrow as to resemble the stream of high velocity water emitted by a firehose, or slightly more dispersed so as to resemble a non-circular coverage area defined by a major diameter and a shorter minor diameter.

Preferably, each sprinkler head 34 is spaced apart from the next adjacent sprinkler head 34 by a regular spacing distance. That is to say, the saddles 32 are evenly distributed along the length supply line 30. As examples, the sprinkler heads 34 may be affixed to the supply line 30 at regular intervals of four fee (4 ft.), or perhaps eight feet (8 ft.), or maybe ten feet (10 ft.). The spacing interval is determined by the type of sprinkler head 34, the physical characteristics of the warehouse and/or the configuration of storage items 24 to be protected.

As stated previously, FIGS. 1-3 depict representative examples of prior art suppressions systems in phantom lines indicated at A. In the prior art, it is customary (code-specified) that sprinkler heads A must be located, typically, twelve-to-eighteen inches (12-18 in.) from the ceiling deck 12 in order to assure a timely response in the event of a fire. The logic behind locating prior art sprinkler heads A in close proximity to the ceiling deck 12 is because of the hot ceiling jets that are known to spread from a fire plume. Installers of fire suppression systems are required to follow established protocols and are held accountable through the building inspection process. For this reason, installers have not felt at liberty to locate prior art sprinkler heads A greater than the code-specified distance from the ceiling deck 12. In other words, just like architects and builders, installers of prior art fire suppressions systems must follow the rules or risk failure to pass inspections. Thus, it would be unthinkable for installers of prior art fire suppressions systems to position sprinkler heads greater than the pre-approved distance from the ceiling deck 12, which is typically twelve-to-eighteen inches (12-18 in.).

However, in perhaps all large warehouse buildings, the metallic structural support members 14 are deeper than eighteen inches (18 in.), thus necessitating that the prior art supply lines be run (plumbed) through/around the metallic structural support members 14. In cases where the metallic structural support members 14 are solid I-beams as in the example of FIG. 4, it is only possible to run a prior art supply line parallel with the I-beams unless the saddles are fitted with long extensions to locate the sprinkler heads close to the ceiling deck 12. In cases where the metallic structural support members 14 are trusses as in the examples of FIG. 1-3, a prior art supply line can be run parallel with the trusses, but more likely will be routed perpendicular to pass through the webs 20. A major annoyance factor with all of these prior art routing strategies is that during the installation process it is time-consuming and cumbersome to locate supply lines through/around the metallic structural support members 14, not to mention added obstacles like HVAC ductwork and electrical lines that are also commonly tucked in-between the metallic structural support members 14.

In addition to the increased installation costs, the prior art practice of locating sprinkler heads A twelve-to-eighteen inches (12-18 in.) from the ceiling deck 12 also results in significant disturbance to the emitted water spray patterns D. When prior art sprinkler heads are tucked in-between the metallic structural support members 14 or run through truss webs 20, many surrounding obstacles (including HVAC ductwork) will disrupt the water spray geometry D resulting in an uneven distribution over the intended coverage area.

Warehouse type building structures are very different from those designed for most other uses. For one, warehouses are typically very large with high ceiling decks 12 to permit storage large quantities of storage items 24 stacked many levels high on storage racks 26. Typically, there is a flammable quality to the storage items 24, be it the storage items 24 per se, or their combustible boxing/crating/wrapping or the wooden pallets on which they are carried. In practical terms, therefore, the orderly placement of large quantities of combustible storage items 24, all separated by narrow air shafts (flues), make ideal conditions for rapid spread of fires. It is fair to say that a warehouse loaded with storage items 24 is like a tinder box. Once sparked, a warehouse fire can swiftly grow into a raging inferno with devasting effect.

It is also the case that warehouses tend to be constructed as economically as possible, which means that usually the metallic structural support members 14 are left exposed to the storage area. As a result, heat from a fire in the storage area will directly contact the metallic structural support members 14 without an intervening barrier such as a drop ceiling. Prior art, sprinkler heads A are located, typically, twelve-to-eighteen inches (12-18 in.) from the ceiling deck 12 in order to assure a timely response in the event of a fire. Thus, prior art supply lines are run through/around the metallic structural support members 14 at greater installation cost and greater interference with spray patterns.

These and other factors make warehouses a special challenge to adequately protect with prior art fire suppression systems/techniques. One particularly novel and advantageous feature of the present invention is that each sprinkler head 34 is suspended much farther below the ceiling deck 12, so that the entirety of its spray geometry 35 is completely below any structural interferences. In particular, the sprinkler heads 34 are intentionally located so that their defined spray geometry 35 will propagate below the metallic structural support members 14 (or girders, trusses, etc.) in the building structure, thus positioning the sprinkler heads 34 closer to combustibles and away from ceiling-level obstructions like beams, trusses, ductwork, etc. In one embodiment, each supply line 30 is also suspended so as to run continuous and uninterrupted within the storage area completely below any structural interferences. Specifically, as shown in FIGS. 1-4, the supply line 30 and the sprinkler heads 34 are disposed below the bottom chords 18 of all metallic structural support members 14. In the illustrated examples, the supply line 30 is shown extending perpendicularly to the metallic structural support members 14. However, in other contemplated embodiments the supply line 30 may be installed parallel to the metallic structural support members 14.

The advantages of suspending sprinkler heads 34 low enough so that their spray geometries 35 spread out entirely below the metallic structural support members 14 are many, even though it is understandable why installers of prior art fire suppressions systems would never attempt to locate sprinkler heads greater than the pre-approved distance from the ceiling deck 12, which is typically twelve-to-eighteen inches (12-18 in.). Locating sprinkler heads 34 near or below the bottom chord 18 of the exposed metallic structural support members 14 enables water spray 35 to be emitted without obstruction. The sprinkler heads 34 will always be in a position that the structural members 14, HVAC ducts and other ceiling area infrastructure will not interrupt or obstruct the sprayed water flow patterns 35.

Locating sprinkler heads 34 near or below the metallic structural support members 14 allows the sprinkler heads 34 to be spaced at ideal design intervals rather than intervals dictated (or at least influenced) by ceiling-level obstructions. As a corollary to the ideal design interval advantage, the sprinkler heads 34 may, optionally, be spaced closely (e.g., four or five feet) which will enable use of smaller pipe diameters. Locating sprinkler heads 34 below the metallic structural support members 14 has the very recognizable advantage of permitting obstruction-free spray patterns. Coverage areas in the warehouse can be uniformly wetted in the event of a fire. Locating sprinkler heads 34 near or below the metallic structural support members 14 also allows the sprinkler heads 34 to be located closer in proximity to the locus of fire. The sprayed water is required to travel a shorter distance before wetting surfaces, which means less opportunity for the water spray to vaporize in flight. These are but a few of the many benefits achieved by challenging the prior art paradigm that insists to locate sprinkler heads within twelve-to-eighteen inches (12-18 in.) of the ceiling deck 12.

Another significant factor, previously unreported, is that metallic structural support members 14 naturally present major heat transfer systems that inherently deflect and absorb heat from fires. By lowering the sprinkler heads 34 near or below the metallic structural support members 14, the reflected heat can be exploited so as to contribute to rapid activation of the trigger elements through agents of conduction, radiation and convection. Also, the metallic structural support members 14 can interrupt the flow of hot air and gas, forcing these currents down from the ceiling deck 12 faster with greater velocity. It will be understood that the relative impact of the metallic support member 14 induced heat transfer varies depending on building height, structural steel sizes, storage height and arrangement, etc. That is to say, the configuration, height, commodity, aisle width, storage height and steel depth all contribute something toward the success of this method of installation.

Optionally the supply lines 30 also can be positioned entirely below the metallic structural support members 14. Suspending supply lines 30 below the metallic structural support members 14 substantially lowers installation costs, because there is little or no need to weave supply lines 30 around ceiling-level obstructions. Longer lengths of pipe can be used, thus reducing the number of (leak-prone) couplings otherwise needed to join multiple shorter-lengths of pipe. Smaller pipe diameters are lower cost, easier/lighter to install and can accommodate a smaller flow rate of water supply than a traditional large diameter supply line of the prior art. And the need to route around obstacles (e.g., ductworks) is reduced or even eliminated, thereby improving water flow rates (less head loss) through the pipe. Reductions in head loss translate to less water and pressure to be required resulting in further material and labor savings.

The supply lines 30 may be suspended below the metallic structural support members 14 using any suitable accommodation. In the illustrated examples of FIGS. 1-3, suspension is accomplished using a hanger bracket 38 directly connecting the supply line 30 to at least one of the metallic structural support members 14 to suspend the supply line 30 below the metallic structural support members 14. In some cases, it will convenient to directly attach the hanger bracket 38 to the bottom chord 18 of the metallic structural support member 14. But of course, other attachment points are possible. Thus, it can be appreciated how expedient installation of a fire suppression system 10 can be according to the techniques of this invention. In situations where it is desired to locate the sprinkler heads 34 relatively close to the top of the storage items 24, Conversely, if maximum clearance is needed, relatively short hanger brackets 38 can be used.

Sometimes in may be necessary to run the supply line(s) 30 above the bottom chord 18 of a truss or I-beam. In these situations, pendant-style sprinkler heads 34 can be fitted with a small extension from the respective saddles 32 to achieve a position for each sprinkler head 34 below the bottom chord 18.

A fire (FIG. 4) produces hot combustion gases that travel upwardly through a narrow plume B like an invisible chimney. The rising heat plume B contacts the ceiling deck 12 and turns to form ceiling jets C. When the escaping heat is sufficient to activate at least one nearby overhead sprinkler head 34, water will be discharged from the supply line 30.

Because of the unique “tinder box” nature of warehouses, it is reasonable to expect that the heat produced by a fire outbreak will grow so quickly, that the response time of any standard sprinkler head (i.e., those designed for placement twelve-to-eighteen inches from ceiling deck 12) will not be adversely affected. That is to say, the novel approach to support a fire suppression system 10 below the exposed metallic structural support members 14 does not preclude use of commercial off-the-shelf sprinkler heads 34.

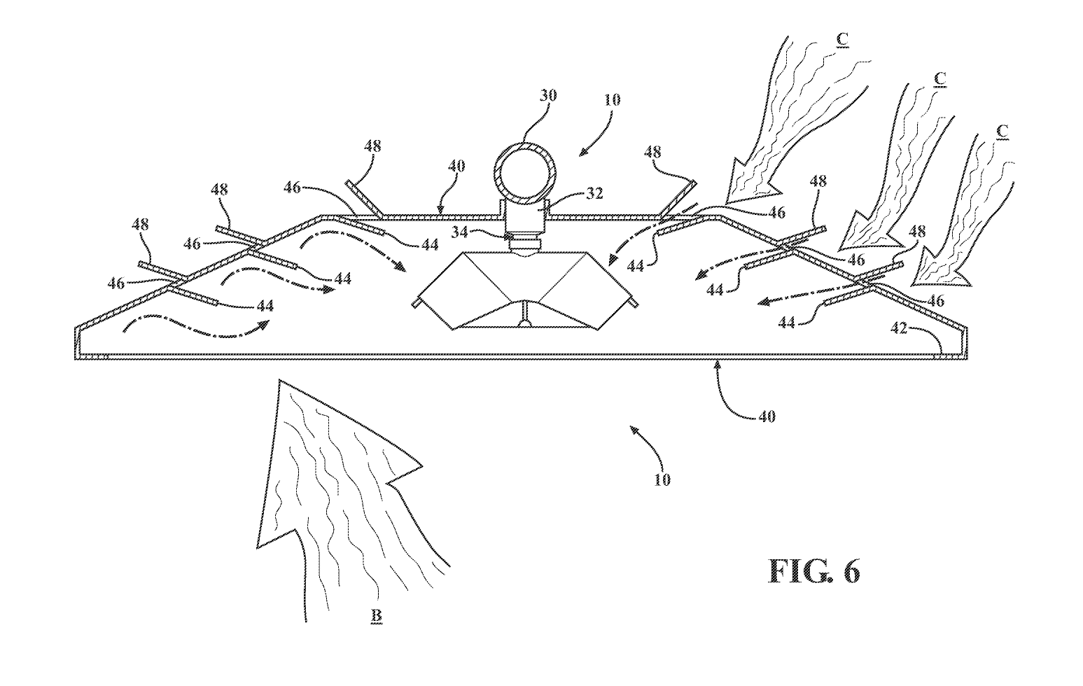

In situations where the trigger response time is feared too slow, one or more sprinkler heads 34 may be mated with a dedicated heat collector, generally indicated at 40. Each heat collector 40 is operatively associated with a respective sprinkler head 34. Heat collectors 40 can be configured to accommodate all styles of sprinkler heads 34, including upright (FIG. 2 far left; FIGS. 4-5), pendant (FIG. 2 center; FIG. 6) and side discharge (FIGS. 7-8). Typically (but not necessarily) for upright sprinkler heads 34, the heat collector 40 will be supported from the deflector 36 to avoid disturbances in the flow of emitted water. This is upright configuration is exemplified in FIGS. 4 and 5. In pendant and side-discharge applications, it may be convenient to affix the heat collector 40 directly to the associated saddle 32. Examples of saddle-supported configurations are depicted in FIGS. 6-8. Naturally, other connection options can be devised to support a heat collector 40.

The heat collector 40 itself can take many different configurations, but in all forms can be seen having a generally concave interior surface and a generally convex external surface. For example, the heat collectors 40 of FIGS. 4-6 take the general shape of a lamp shade or inverted bowl. The concave interior surface captures and concentrates heat toward/around the trigger of its associated sprinkler head 34. The convex external surface helps deflect water spray from nearby activated sprinkler heads 34, so as to protect against an unwelcome cold-soldering situation that might retard trigger activation. The Applicant's related US Publication No. 2019/0099630 provides numerous examples of different design configurations for heat collectors 40. In the illustrated examples of this present document, each heat collector 40 includes an optional inswept rim 42 at least partially encircling the concave interior region. The rim 42 fully encircles the heat collector 40 in the example of FIGS. 5 and 6, whereas the rim 42 only partially encircles the heat collector 40 in the example of FIGS. 7 and 8. In all of these variations, the rim 42 serves to help trap heat plumes B to encourage rapid triggering of its sprinkler head 34.

The heat collectors 40 of FIGS. 4-6 illustrate alternative embodiments in which a plurality of internal fins or louvers 44 extend from the interior surface for passively directing upwardly rising currents of hot air (heat plumes B) toward the trigger of the sprinkler head 34. Also, the internal louvers 44 help generate a turbulent flow of hot convective gases in and around the vicinity of the triggering element in the sprinkler 34, which is believed to improve activation responsiveness. These interior louvers 44 curl and route upwardly rising heat from the plume B toward the sprinkler 34, as shown in FIGS. 5 and 6.

Typically, the interior louvers 44 will be employed in conjunction with vents or aspiration ports 46. One (or multiple) aspiration port 46 is disposed in the heat collector 40 directly above each interior louver 44. Air may flow freely through the aspiration ports 46. The purpose of the aspiration ports 46 is to allow hot, transversely flowing air currents (ceiling jet C) to enter into the concave heat collecting region of the heat collector 40. By positioning an interior louver directly below aspiration port 46, beneficial hot air is discouraged from exiting the concave heat collecting region of the heat collector 40. In other words, the combination of interior louvers 44 and aspiration ports 46 loosely form a natural check-valve situation where hot air can enter more easily than it can escape. Slot-like aspiration ports 46 are contemplated, however the aspiration ports 46 could take any suitable shape. Although the simplified cross-sectional views of FIGS. 5 and 6 depict aspiration ports 46 on only two opposing sides of the heat collector 40, it is expected that aspiration ports 46 will be arranged about the entire periphery to accommodate air flows from all directions. The aspiration ports 46 could be angled or geometrically shaped and/or sized to maximize functionality.

The intake of hot, transversely flowing air currents (ceiling jet C) into the concave heat collecting region of the heat collector 40 can be facilitated by the addition of exterior fins or louvers 48. Each exterior louver 48 extends from the outside surface of the heat collector 40 directly above an associated aspiration port 46. As can be seen in the depictions of FIGS. 4-6, the exterior louvers 48 can behave like small scoops to help direct transiting ceiling jets C through the respective the aspiration port 46. Air flowing across the interior louvers 44 can move faster than air flowing around the outside of the heat collector 40. The difference in air speed can create a beneficial venturi effect helping to draw hot external air in through the aspiration ports 46. With the combination of louvers 44,48 and aspiration ports 46, the heat collector 40 can be even more efficient at capturing the hot, transversely flowing ceiling jet C into the concave heat collecting region of the heat collector 40. The interior louvers 44 temporarily segregate the curling plume air B from the in-drafted ceiling jet air C, generating a swirling concentration of hot eddy currents that disrupt and prevent the unwanted formation of dead air spaces under the heat collector 40. The congregating hot gasses from both plume B and ceiling jet C churn under the heat collector 40 like a whirlpool air bath that rapidly activates the trigger of the sprinkler 34. The turbulent, collected heat is transferred to the trigger element primarily by convection.

Like the aspiration ports 46, the interior louvers 44 and exterior louvers 48 can be angled or geometrically shaped and/or sized to maximize functionality. Fire testing will inform those of skill in the art to different sizes and geometries that will maximize efficiency of these cooperating elements. And to be clear, the louvers 44, 48 and aspiration ports 46 could be added anywhere around the collector 40 top and bottom, including along its the leading edges and under the edges (not shown), to create additional up-draft of heat. Such up-draft inducing features could be added to any of the several embodiments of this invention.

When the heat collector 40 is to be used in conjunction with non-circular sprinkler heads 34 like these, the heat collector 40 may have a shape (as viewed from above) generally corresponding to the coverage area. For example, if the sprinkler head 34 produces an elliptical coverage area defined by L≈0.6 W, then the heat collector 40 may be shaped in the form of an ellipse so that its major axis measure is approximately 0.6 times its minor axis dimension. Or in another example, if the sprinkler head 34 produces a circular coverage area, then the heat collector 40 may be shaped in the form of a circle. However, this is not to preclude formation of the heat collector 40 in other geometric shapes, including but not limited to round (circular) and polygonal for any type or design of coverage area produced by the associated sprinkler 34. In other words, the shape of the heat collector 40 may mimic the shape of the coverage area produced by the associated sprinkler 34, however this shape-matching is optional. Ideally, the heat collector 40 will be configured so as not to obstruct the spray pattern from the sprinkler head 34. Preferably, the size of the heat collector 40 will be determined by the type of fire hazard it is protecting. Ideally, the shape of the heat collector 40 will be configured to maximize heat collection.

The heat collectors 40 better enable the sprinkler heads 34 to be located far away from the ceiling deck 12 (i.e., beyond current fire code limits) while still maintaining adequate activation responsiveness. By locating sprinkler heads 34 far below the ceiling deck 12, structural members, barriers and obstructions can be avoided resulting in substantial decreases in material and labor costs. Another advantage is water density. When the sprinkler heads 34 are mounted far below the ceiling deck 12, they are closer to where most fires originate. Smaller clearances between sprinkler head 34 and floor-level combustibles means that the correct sprinkler 34 water density will be delivered to a fire. Closer sprinklers 34 means greater water density at the combustion site.

The heat collector 40 is designed to overcome the drawbacks of prior art heat collectors 40, namely that the prior art versions produced dead air spaces and prevented the ceiling jet C from reaching the sprinkler 34. The heat collector 40 of this invention addresses these prior art critiques by scavenging heat from the ceiling jet C and generating a turbulent flow of hot convective gases in and around the vicinity of the triggering element in the sprinkler 34.

As described above, the heat collector 40 can be made porous so that convective currents in the ceiling jet C will be shunted into the sheltered space of the heat collector 40. The present invention may include a variety of other features designed to scavenge heat from the ceiling jet C.

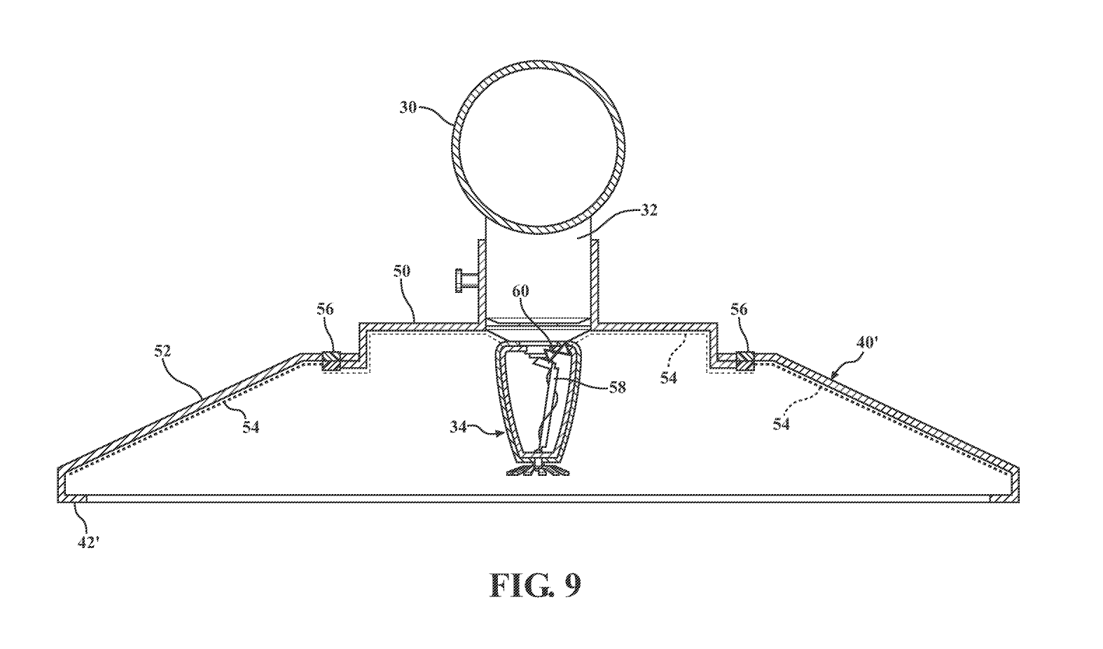

FIG. 9 illustrates yet another alternative embodiment of the heat collector 40′ having an inswept rim 42′. In this example, the sprinkler head 34 is depicted in the form of a traditional pendant type configured to produce a circular spray pattern. The heat collector 40′ in this example does not include the aforementioned ports and louvers 44-48. However, ports and louvers 44-48 could optionally be combined into this embodiment with added beneficial effect. The heat collector 40′ is shown in cross-section configured as a novel two-piece design having a mounting component 50 and a skirt component 52. The mounting component 50 may be attached to the sprinkler frame or saddle 32 or other suitable supporting structure at the factory, or by the installer in the field. Then at a later convenient time, the skirt component 52 is attached to the mounting component 50 to complete the assembly.

In this embodiment, heat scavenging is supplemented by use of an integrated heat antenna 54. The heat antenna(e) 54 may take any suitable form of device or formation that absorbs heat from ambient sources, e.g., from the plume B and/or the ceiling jet C and/or radiant heat energy from all emitting local sources. In the illustrated example, a plurality of strands of heat antennae 54 extend like spokes toward the outer peripheral edges of the heat collector 40′. The heat antennae 54 conductively transmits the absorbed heat to the trigger of the sprinkler head 34. Such heat antennae 54 can be located along the exterior (convex) side of the heat collector 40′, the inside surface of the heat collector 40′ and/or placed on or near the ceiling deck 12.

A transmissive heat coupling 56 enables an efficient conduction of heat across the interface between mounting 50 and skirt 52 components. Of course, the transmissive heat coupling 56 can be omitted in configurations where a physical break along the length of the heat antennae 54 is not required. A heat tether 58 extends between the heat antennae 54 and the trigger of the sprinkler 34. The heat tether 58 acts like a receiving manifold to the one or more heat antennae 54, conductively moving the accumulated heat toward the trigger. The illustrations depict the heat tether 58 wound directly around the triggering element, however in some contemplated embodiments the heat tether 58 terminates slightly spaced from the trigger so as not to directly interfere with its functionality. The heat tether 58 can be suitable material. In some contemplated embodiments, the heat tether 58 can be integrated directly into the solder/glass bulb, or whatever element is used to improve response time by internally adding heat scavenged from the ambient hot air. To maintain compliance with factory settings, at least a portion of the heat tether 58 is preferably assembled with the trigger at the factory. As shown schematically in FIG. 10, a terminal connection 60 may be used to establish a quick connection (and disconnection) of the heat tether 58 to the heat antennae 54.

It will be appreciated by those skilled in the art that the heat antennae 54 can take any suitable form, including but not limited to wires, absorption tubes, channels and the like. The heat antennae 54 not only provide conduction but could be designed to transfer radiant hot gas into the sheltered space under the heat collector 40′. In FIG. 10, the heat antennae 54 are suggested by dashed lines, which are intended to represent heat collecting wires or tubes or other suitable formations along the interior (concave) side of the heat collector 40′. These integrated heat antennae 54 can also be located along the exterior (convex) side of the heat collector 40′ and/or can be remotely-located to objects or areas in which the signs of heat from a fire are likely to initially manifest. For example, it may be desirable to locate strands of heat collecting wires or tubes near the ceiling deck 14 and/or along strategic surfaces of the metallic structural support members. Indeed, external strands of heat antennae 54 could be placed at any angle and/or be made of any material that would benefit these described purposes.

Finally, it must be recognized that the heat collectors 40, 40′ of this invention may be used in all types of structures, including but not limited to warehouses that have a ceiling deck 12 supported by open-framework metal structural support members 14. Likewise, heat collectors 40, 40′ of this invention may be used in conjunction with sprinkler heads 34 located below metallic structural support members 14 as well as those located within twelve-to-eighteen inches of the ceiling deck 12.

The invention also contemplates a method for installing a fire suppression system 10 in a warehouse that has a ceiling deck 12 supported by open-framework metal structural support members 14. The method includes the step of suspending an elongated tubular water supply line 30 along a continuous and uninterrupted path below the ceiling deck 14. A plurality of sprinkler heads 34 are operatively connected to the supply line 30 and positioned relative to the exposed metallic structural support members 14 so that the defined spray geometry 35 emanating from each sprinkler head 34 does not intersect any of the metallic structural support members 14.

The foregoing invention has been described in accordance with the relevant legal standards, thus the description is exemplary rather than limiting in nature. Variations and modifications to the disclosed embodiment may become apparent to those skilled in the art and fall within the scope of the invention. Furthermore, particular features of one embodiment can replace corresponding features in another embodiment or can supplement other embodiments unless otherwise indicated by the drawings or this specification.

What is claimed is:

1. A combination fire suppression system and warehouse comprising:
a warehouse having a ceiling deck covering a storage area, a plurality of metallic structural support members supporting said ceiling deck, said metallic structural support members being exposed to said storage area such that heat from a fire in said storage area will directly contact said metallic structural support members without an intervening barrier, said metallic structural support members arranged in parallel and separated one from another by a lateral spacing, each said metallic structural support member having a top chord in direct contact with said ceiling deck and a bottom chord exposed to said storage area below,
at least one elongated tubular supply line configured as a conduit to carry liquid water, said supply line operatively connected to a source of liquid water,
a plurality of sprinkler heads extending from said supply line, each said sprinkler head receiving liquid water from said supply line and configured to emit the water in a spray of defined geometry, each said sprinkler head having a temperature-sensitive trigger operatively associated with a water release valve,
and wherein said sprinkler heads are located so that said water spray of defined geometry is below said bottom chords of each of said metallic structural support members.

2. The combination of claim 1, wherein said supply line extends continuous and uninterrupted suspended below said bottom chords of each of said metallic structural support members, further including a hanger bracket directly connecting said supply line to at least one of said metallic structural support members to suspend said supply line below said metallic structural support members.

3. The combination of claim 2, wherein said hanger bracket directly attaches to said bottom chord of said metallic structural support member.

4. The combination of claim 1, further including a heat collector operatively associated with at least one of said sprinkler heads, said heat collector having a generally concave interior surface and a generally convex external surface.

5. The combination of claim 4, wherein said heat collector includes an inswept rim at least partially encircling said concave interior region.

6. The combination of claim 5, wherein said supply line includes a plurality of saddles perpendicularly radiating therefrom, each said sprinkler head coupled to a respective one of said saddles, said heat collector directly affixed to said one of said saddles.

7. The combination of claim 4, wherein said heat collector includes a plurality of interior louvers extending from said interior surface for directing upwardly rising heat plumes toward said trigger of said sprinkler head.

8. The combination of claim 7, wherein said heat collector includes an aspiration port disposed in said heat collector directly above each said interior louver.

9. The combination of claim 4, wherein said heat collector includes a plurality of aspiration ports disposed in said heat collector, a exterior louver extending from said exterior surface directly above each said aspiration port for directing transiting ceiling jets through the respective said aspiration port.

10. The combination of claim 4, wherein said heat collector includes a plurality of interior louvers extending from said interior surface for directing upwardly rising heat plumes toward said trigger of said sprinkler head, an aspiration port disposed in said heat collector directly above each said interior louver, a exterior louver extending from said exterior surface directly above each said aspiration port for directing transiting ceiling jets through the respective said aspiration port.

11. The combination of claim 1, wherein each said sprinkler head includes a deflector configured to disperse the liquid water in a jet stream having a downward trajectory over a non-circular coverage area, and wherein each said sprinkler head is spaced apart from the next adjacent sprinkler head by a regular spacing distance.

12. A combination fire suppression system and warehouse comprising:
a warehouse having a ceiling deck covering a storage area, a plurality of metallic structural support members supporting said ceiling deck, said metallic structural support members being exposed to said storage area such that heat from a fire in said storage area will directly contact said metallic structural support members without an intervening barrier, said metallic structural support members arranged in parallel and separated one from another by a lateral spacing, each said metallic structural support member having a top chord in direct contact with said ceiling deck and a bottom chord exposed to said storage area below,
at least one elongated tubular supply line configured as a conduit to carry liquid water, said supply line extending continuous and uninterrupted within said storage area, said supply line operatively connected to a source of liquid water,
a plurality of sprinkler heads extending from said supply line, each said sprinkler head receiving liquid water from said supply line and configured to emit the water in a spray of defined geometry, each said sprinkler head having a temperature-sensitive trigger operatively associated with a water release valve, said sprinkler heads being located so that said water spray of defined geometry is below said bottom chords of each of said metallic structural support members, and
a heat collector operatively associated with each of said sprinkler heads.

13. The combination of claim 12, wherein each said heat collector has a generally concave interior surface and a generally convex external surface, a plurality of interior louvers extending from said interior surface for directing upwardly rising heat plumes toward said trigger of said sprinkler head, an aspiration port disposed in said heat collector directly above each said interior louver, a exterior louver extending from said exterior surface directly above each said aspiration port for directing transiting ceiling jets through the respective said aspiration port.

14. The combination of claim 13, wherein said heat collector includes an inswept rim at least partially encircling said concave interior region.

15. The combination of claim 12, wherein said supply line includes a plurality of saddles perpendicularly radiating therefrom, each said sprinkler head coupled to a respective one of said saddles, said heat collector directly affixed to said one of said saddles.

16. The combination of claim 12, further including a hanger bracket directly connecting said supply line to at least one of said metallic structural support members to suspend said supply line below said metallic structural support members, said hanger bracket directly attached to said bottom chord of said metallic structural support member.

17. The combination of claim 12, wherein each said sprinkler head includes a deflector configured to disperse the liquid water in a jet stream having a downward trajectory over a non-circular coverage area, and wherein each said sprinkler head is spaced apart from the next adjacent sprinkler head by a regular spacing distance.

18. A method for installing a fire suppression system in a warehouse having a ceiling deck supported by exposed metallic structural support members, said method comprising the steps of:
supporting an elongated tubular water supply line below the ceiling deck, the supply line having a plurality of sprinkler heads extending therefrom, connecting the supply line to a liquid water source, and positioning the sprinkler heads below a bottom chord of the metallic structural support members.

19. The method of claim 18 wherein said supporting step includes attaching a hanger bracket directly to the bottom chord of at least one metallic structural support member.

20. The method of claim 18 further including the step of surrounding each sprinkler head with a heat collector having a generally concave interior surface and a generally convex external surface.
